(19) United States
(12) Patent Application Publication
(10) Pub. No.: US 2013/0262486 A1
(43) Pub. Date: Oct. 3, 2013

(54) Encoding and Decoding of Small Amounts of Text

(71) Applicants: Robert B. O'Dell, (US); James D. Ivey, (US)

(72) Inventors: Robert B. O'Dell, (US); James D. Ivey, (US)

(21) Appl. No.: 13/483,042

(22) Filed: May 29, 2012

Related U.S. Application Data
(63) Continuation-in-part of application No. 13/418,278, filed on Mar. 12, 2012.
Application No. 13/418,278 is a continuation-in-part of application No. 12/715,244, filed on Mar. 1, 2010.
(60) Provisional application No. 61/491,177, filed on May 28, 2011.
(60) Provisional application No. 61/542,791, filed on Oct. 3, 2011.
(60) Provisional application No. 61/280,683, filed on Nov. 7, 2009.
(60) Provisional application No. 61/284,634, filed on Dec. 21, 2009.

(51) Int. Cl. G06F 17/30

(52) U.S. Cl. CPC G06F 17/3061
USPC 707/755

(57) ABSTRACT

Text compression and encryption is achieved by using a predetermined dictionary not unique to the encoded text to substitute codes for words and phrases thereby obviating transmission of the dictionary along with transmitted encoded text. The codes of the dictionary are made of one or more text characters such that the message, once encoded, continues to be a legitimate text message and can travel through any data transport medium through which a conventional unencoded text message can travel. Non-word characters delimit codes and unencoded words in an encoded message. Advantages include message filtering and maintaining message threads of short messages, including SMS.

### CROSS-REFERENCE TO RELATED APPLICATIONS

This application claims priority of U.S. Provisional Patent Application Ser. No. 61/491,177 filed May 28, 2011 entitled “Encrypting, Compressing And Filtering Text And Text Messages Small Or Large” by Robert B. O'Dell and U.S. Provisional Patent Application Ser. No. 61/542,791 filed May 28, 2011 entitled “Compressing, Encrypting And Filtering Text And Text Messages” by Robert B. O'Dell and is a continuation-in-part of U.S. patent application Ser. No. 13/418,278 filed Mar. 12, 2012 entitled “Encoding and Decoding of Small Amounts of Text” by Robert B. O'Dell and James D. Ivey, which is a continuation-in-part of U.S. patent application Ser. No. 12/715,244 filed Mar. 1, 2010 by Robert B. O'Dell and James D. Ivey and entitled “Using The Encoding Of Words And Groups Of Words To Compress Computer Text Files”, which in turn claims priority of U.S. Provisional Patent Application Ser. No. 61/280,683 filed Nov. 7, 2009 entitled “Using a Standard Encoding/Decoding Dictionary to Compress Computer Text Files” by Robert B. O'Dell and of U.S. Provisional Patent Application Ser. No. 61/284,634 filed Dec. 29, 2009 entitled “Using the Encoding and Decoding of Words and Groups of Words to Compress Computer Files” by Robert B. O'Dell.

### FIELD OF THE INVENTION

The present invention relates generally to storage and transmission of computer data, and, more particularly, methods of and systems for encoding and decoding small amounts of text data.

### BACKGROUND OF THE INVENTION

Text data compression is widely used to send very large files between computers on a network. The compression is most commonly accomplished through pattern recognition techniques which identify repeated patterns within the text data and build a translation dictionary in which various smaller sets of characters are substituted for each such pattern to thereby encode the text using less data. When transmitted, the encoded text is accompanied by the translation dictionary since the dictionary is necessary to decode the text after it is received. But, for two very good reasons, only large amounts of text data are compressed before transmission.

One reason has to do with the dearth—or even the absence—of patterns in small amounts of text data. In general, the longer the text string, the more patterns are repeated in that string.

But there is another transmission issue which discourages compression of any but quite sizable amounts of text: the translation dictionary that maps recognized repeating patterns to abbreviated representation is unique to each compressed file and therefore must be sent along with the compressed text if the text is to be decoded upon reception. Thus, conventional text compression is only cost-effective if the amount of data reduced by replacing recognized repeating patterns with abbreviated representations is sufficient to justify transmission of the dictionary that maps those patterns to their respective representations along with the abbreviated text data. This is certainly not true for most small text messages.

The consequence of the inability of conventional compression techniques to efficiently compress small texts and the need to send the translation dictionary along with the text means that many common transmissions of text—including most e-mail and cellphone texting (SMS, Short Messaging Service, messages) as well as Web page textual content—are not compressed. But, considering the daily network volume of such text, compression of these smaller text files would reduce significantly the volume of internet traffic and would reduce the amount of storage space needed at the short message centers that ‘store and forward’ text messages over mobile phone networks. The reduced size of short text files would also reduce the amount of storage space used on the various personal and corporate computer storage media.

### SUMMARY OF THE INVENTION

In accordance with the present invention, text is encoded using a scheme which, in the preferred embodiment, uses a predetermined dictionary not unique to the compressed text to substitute codes of one or more characters for words and phrases, thereby obviating transmission of the dictionary along with transmitted encoded text. In particular, the predetermined dictionary is created independently of any particular body of text. Shorter codes, including codes of a single character, are used to represent words and phrases most frequently used generally, while the generally least frequently used words and phrases are represented by longer codes. The substitution of words and phrases for predetermined codes provides substantial compression of the text data and provides significant privacy as the original text is not readily discernible from the encoded text without access to the dictionary. In effect, the dictionary can be considered a multi-megabyte encryption key.

Frequency of usage is determined generally, across of a population of representative text and not from any particular body of text. As a result, the predetermined dictionary can be shared by a sender and a receiver and thereafter used to encode/decode many bodies of text traveling there between.

The codes of the predetermined dictionary are made of one or more text characters such that the message, once encoded, continues to be a legitimate text message. The encoded message can therefore travel through any data transport medium through which a conventional text message can travel.

During encoding of a subject body of text, words or phrases not represented in the predetermined dictionary are copied in original form into the encoded message. Any such word or phrase that can be confused with a code, e.g., is no longer than the longest code, is flagged to indicate that it is not a code. For example, the word can be prefixed with a predetermined flag such as apostrophe. The predetermined flag is not used as an initial character of a code, thereby making all codes distinguishable from words flagged. In decoding, the flag is recognized as such and is removed from the word.

Better compression and obfuscation is achieved by recognizing and omitting common whitespace patterns. For example, a single space character can be implicit between every code of an encoded message. Adjacent codes are distinguished from one another by a marker portion of the code at one end. Such a marker can be a code character selected from a subset of code characters designated as marker characters.

### A BRIEF DESCRIPTION OF THE DRAWINGS

FIG. 1 is a block diagram of a computer system configured to encode/decode text data for lossless compression thereof using a predetermined dictionary of phrases and representative codes in accordance with the invention.

FIG. 2 shows a mobile telephone that can act as the computer system of FIG. 1.

FIG. 3 is a transaction flow diagram showing the encoding, sending, receiving, decoding and displaying of text data in accordance with the invention.

FIG. 4 is a block diagram showing the transmission of encoded and compressed text data over a computer network using the predetermined dictionary resident on both the sending device and the receiving device in accordance with the invention.

FIG. 5 is a logic flow diagram illustrating encoding of text data to effect compression thereof in accordance with the present invention.

FIG. 6 is a logic flow diagram illustrating the location of a longest represented phrase in a step of the logic flow diagram of FIG. 5.

FIG. 7 is a logic flow diagram of the use of flags to encode phrases matching patterns of associated flags.

FIG. 8 is a logic flow diagram illustrating decoding of text data to effect decompression thereof in accordance with the present invention.

FIG. 9 is a logic flow diagram of the recognition of flags to decode phrases matching patterns of associated flags.

FIGS. 10 and 11 are logic flow diagrams illustrating run-length encoding and decoding, respectively, of strings of characters otherwise not encoded and decoded according to logic flow diagrams of FIGS. 5 and 8, respectively.

FIG. 12 is a block diagram of a computer system that includes dictionary optimization logic for populating the predetermined dictionary with phrases likely to result in good compression when encoding according to the logic flow diagram of Figure

FIG. 13 is a logic flow diagram of the population of the predetermined dictionary by the dictionary optimization logic of FIG. 12.

FIGS. 14 and 15 are logic flow diagrams corresponding to the logic flow diagrams of FIGS. 5 and 8, respectively, according to an alternative embodiment.

FIG. 16 is a block diagram showing the encoding logic of FIG. 1 in greater detail, including the ability to enhance privacy for individual recipients of text messages.

### DETAILED DESCRIPTION OF THE INVENTION

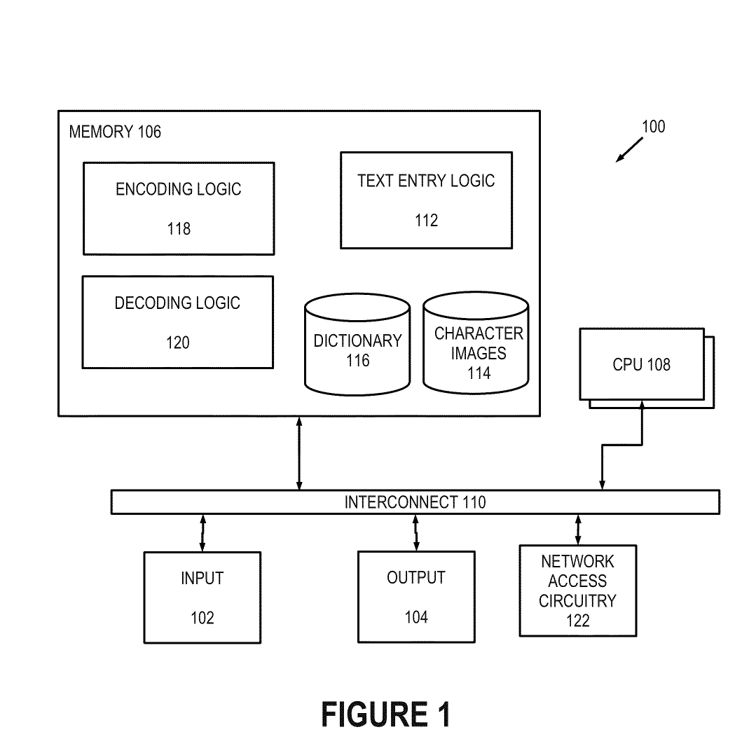

In accordance with the present invention, text data is encoded and decoded by using a predetermined dictionary 116 (FIG. 1) of words and phrases represented by respective codes to thereby obviate transmission of the dictionary along with the encoded text. The codes are constructed of the same characters with which the text data is constructed such that the message, once encoded to include codes rather than their respective associated words or phrases, is itself a text message.

Briefly, text is encoded by replacement of phrases thereof with representative codes from dictionary 116. Since the codes are generally shorter than the represented phrases, such encoding results in compression of the text. Conversely, decoding the message by replacing codes in the encoded message with phrases represented by the respective codes results in decompression and restoration of the text.

Dictionary 116 is predetermined in that dictionary 116 does not depend upon the particular text being encoded—in that dictionary 116 is known before a given message to be encoded by use of dictionary 116 is known. Dictionary 116 is designed to represent commonly-used phrases across all text likely to be compressed with much shorter codes. Since dictionary 116 is predetermined and not constructed from the text to be encoded, there is no need to transmit dictionary 116 along with the encoded text. As a result, short messages that could not be adequately compressed to justify adding a dictionary to the data payload can now be effectively and significantly compressed.

As used herein, a “word” is any string of word characters delimited by non-word characters. Designation of characters as word characters or non-word characters is somewhat arbitrary in that the encoding and decoding methods described herein do not rely on any specific characters being in either set, so long as the two sets are mutually exclusive. As used herein, a “phrase” is a collection of one or more words delimited by one or more non-word characters; thus, a single word can be a “phrase” as defined herein.

It is not necessary that phrases represented in dictionary 116 are English phrases or even phrases of words recognizable as such to human readers. For example, common domain names used in links that can be frequently included in text messages can be recognized by the system described herein as a “phrase.” For example, in the embodiment described more completely below, non-word characters include periods and forward slashes. As a result, a common portion of a Web site URL can be recognized as a phrase. The URL “http://tinyurl.com/abc123” includes a relatively common leading phrase, namely, “http://tinyurl.com”: “http:” as the first word, followed by “II” as whitespace (a string of one or more non-word characters), followed by “tinyurl” as a second word, followed by yet more whitespace (“.”), ending with the word, “com”, and finally delimited from the phrase that follows by a “I” non-word character.

During encoding, phrases are replaced by their associated codes as represented in dictionary 116. Phrases of the subject text not found in dictionary 116 are not represented by a code, but are instead included in the compressed text data in their original form. Phrases that are short enough to be confused with or otherwise capable of being confused with a code representing a compressed phrase are distinguished as such by the insertion during encoding of a specified character, designated as a quotation flag and not used in the codes or, in alternative embodiments, just not used as first character of a code. Any such quotation flag is removed during decoding as described in greater detail below.

The characters used as code characters are characters from the character set used in the particular text data to be encoded and decoded. Typically, the character set can be selected from character sets used on mobile phone networks and the Internet. Generally, any character set can be used. The entirety of the particular character set used is divided into word characters and non-word characters. Codes are constructed from one or more word characters except for a few word characters that are reserved as flags. But by not using non-word characters in codes, non-word characters remain an effective delimiter of both words, phrases, and codes. In some embodiments, codes can include flags as word characters so long as the flag is not the first character of the code. In this illustrative embodiment, flags are included as prefixes and can therefore serve as second or subsequent characters of codes.

Since the same encoding translation dictionary—e.g., dictionary 116—is used both for encoding and decoding of all text, any computer device on which both the encoding translation dictionary and the encoding/decoding logic are resident can decode any message received from another computer device encoded with the same encoding translation dictionary and the same encoding/decoding logic without requiring transmission of dictionary 116 along with the message.

This encoding/decoding process described more completely herein reduces text data of almost any size and is especially useful in reducing the size of small amounts of text data, including those commonly seen in SMS messages, instant messages, e-mail, and Web text. Even text messages of only a single word can often be compressed by a substantial amount using the encoding techniques described herein.

Before describing the encoding and decoding of textual messages in accordance with the present invention, some elements of a computer 100 (FIG. 1) are briefly described. Computer 100 includes one or more microprocessors 108 (collectively referred to as CPU 108) that retrieve data and/or instructions from memory 106 and execute retrieved instructions in a conventional manner. Memory 106 can include persistent memory such as magnetic and/or optical disks, ROM, and PROM and volatile memory such as RAM.

CPU 108 and memory 106 are connected to one another through a conventional interconnect 110, which is a bus in this illustrative embodiment and which connects CPU 108 and memory 106 to one or more input devices 102 and/or output devices 104 and network access circuitry 122. Input devices 102 can include, for example, a keyboard, a keypad, a touch-sensitive screen, a mouse, a microphone. Output devices 104 can include a display—such as a liquid crystal display (LCD)—and one or more loudspeakers. Network access circuitry 122 sends and receives text data through a wide area network such as the Internet and/or mobile device data networks.

A number of components of computer 100 are stored in memory 106. In particular, text entry logic 112, encoding logic 118, and decoding logic 120 are each all or part of one or more computer processes executing within CPU 108 from memory 106 in this illustrative embodiment but can also be implemented using digital logic circuitry. As used herein, “logic” refers to (i) logic implemented as computer instructions and/or data within one or more computer processes and/or (ii) logic implemented in electronic circuitry. Character images 114 and dictionary 116 are data stored persistently in memory 106. In this illustrative embodiment, character images 114 and dictionary 116 are each organized as a respective database.

### The Encoding Translation Dictionary

An encoding translation dictionary used for text transmission, e.g., dictionary 116, can be constructed for any of many different character sets, sets which include not only alphabetic characters of Western Europe, characters of the Cyrillic languages, languages of the Indian sub-continent, Arabic, but also sets including characters of Chinese, Japanese and Korean. In this illustrative embodiment, computer 100 is intended to send brief text messages through SMS networks and/or the Internet. Accordingly, the most useful character sets are those commonly used in transmission of text on mobile phones and the Internet.

The ASCII character set is a subset of the default character set GSM 03.38 used for transmission of text on mobile phone networks in Europe and North America and in parts of Africa, Asia, and the Pacific Islands. Any encoding which uses only characters from the character set GSM 03.38 or a subset of character set GSM 03.38 will be accurately transmitted wherever GSM 03.38 is the character set used for text transmission of an encoded file. In a preferred embodiment, eighty-five (85) displayable ASCII characters, a subset of GSM 03.38, are used as potential word characters. Other embodiments can use different characters sets.

In this illustrative embodiment, encoding logic 118, decoding logic 120, and dictionary 116 share a categorization of every character that can appear in text to be compressed/restored as (i) a word character, (ii) a non-word character, or (iii) a flag character. Flag characters are word characters but are excluded from use as the first 5 character of a code.

TABLE A
Word Characters

| | | | | | | | | | | | | | | | |
|---|---|---|---|---|---|---|---|---|---|---|---|---|---|---|---|
| A | B | C | D | E | F | G | H | I | J | K | L | M | N | O | P |
| Q | R | S | T | U | V | W | X | Y | Z | a | b | c | d | e | f |
| g | h | i | j | k | l | m | n | o | p | q | r | s | t | u | v |
| w | x | y | z | 1 | 2 | 3 | 4 | 5 | 6 | 7 | 8 | 9 | 0 | @ | # |
| $ | % | & | * | ( | ) | < | > | \grave{ } | ~ | : | ; | [ | ] | { | } |
| - | = | + | \| | \ | | | | | | | | | | | |

All characters that can be included in text to be compressed that are not listed in Table A above or Table B below are considered non-word characters.

TABLE B
Flag Characters

| Character | Meaning |
|---|---|
| ‘ (apostrophe) | Quotation |
| _ (underscore) | Initial capital |
| \hat{ } | All capitals |

In this illustrative embodiment, codes used to represent phrases are made from one or more word characters. Dictionary 116 maps these codes to phrases represented by the respective codes. As used herein, a dictionary is a computer-readable data structure that maps individual data elements to equivalent respective data elements. In this embodiment, codes are individual data elements and the equivalent respective data elements are those phrases represented by the respective codes.

These eighty-five (85) single-byte ASCII characters are used (i) as single-character codes to encode the most frequently used phrases, (ii) in groups of two to form two-character codes to encode somewhat less frequently used phrases, and (iii) in groups of three to form three-character codes to encode even less frequently used phrases.

Using the eighty-five (85) word characters listed above, eighty-five (85) unique single-character codes can be used to represent eighty-five (85) phrases; 7,225 unique two-characters codes can be used to represent 7,225 additional phrases; and 614,125 unique three-character codes can be used to represent 614,125 additional phrases. In embedded system embodiments, such as in mobile telephony devices, it may be desirable to limit the size of dictionary 116. Accordingly, dictionary 116 can be limited to codes with a maximum length of two characters, to codes with a maximum length of three characters, or to a maximum number of entries as illustrative examples. In the latter instance, dictionary 116 can be limited to at most 40,000 three-character codes, for example. Where resources permit, larger numbers of codes represented in dictionary 116 tend to provide better rates of encoding. It should be appreciated that codes of four (4) or more characters in length can also be used to store even greater numbers of entries within dictionary 116.

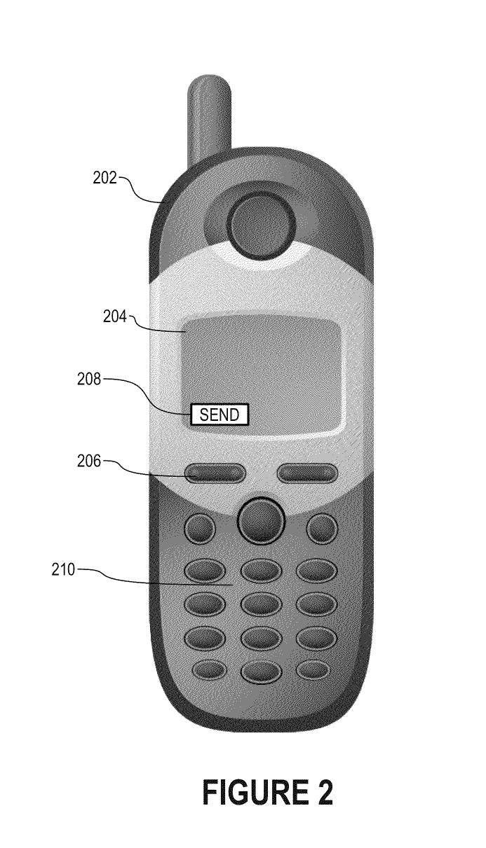

In this illustrative example, a mobile telephone 202 (FIG. 2) is generally of the same organization as is computer 100 (FIG. 1) as described above. Mobile telephone 202 (FIG. 2) includes, as input device(s) 102 (FIG. 1), a keypad 210 (FIG. 2), a button 208, and a soft key 206. Soft key 206 can be implemented in a touch-sensitive screen or can be logically linked with physical button 208 by text entry logic 112 (FIG. 1). In addition, mobile telephone 202 (FIG. 2) includes, as output device 104 (FIG. 1), a display screen 204 (FIG. 2).

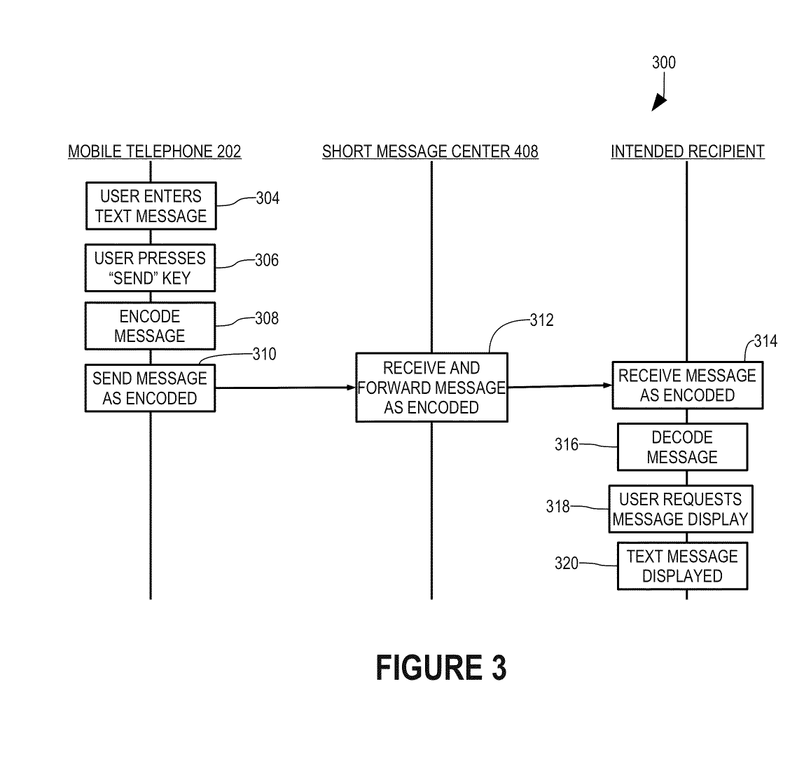

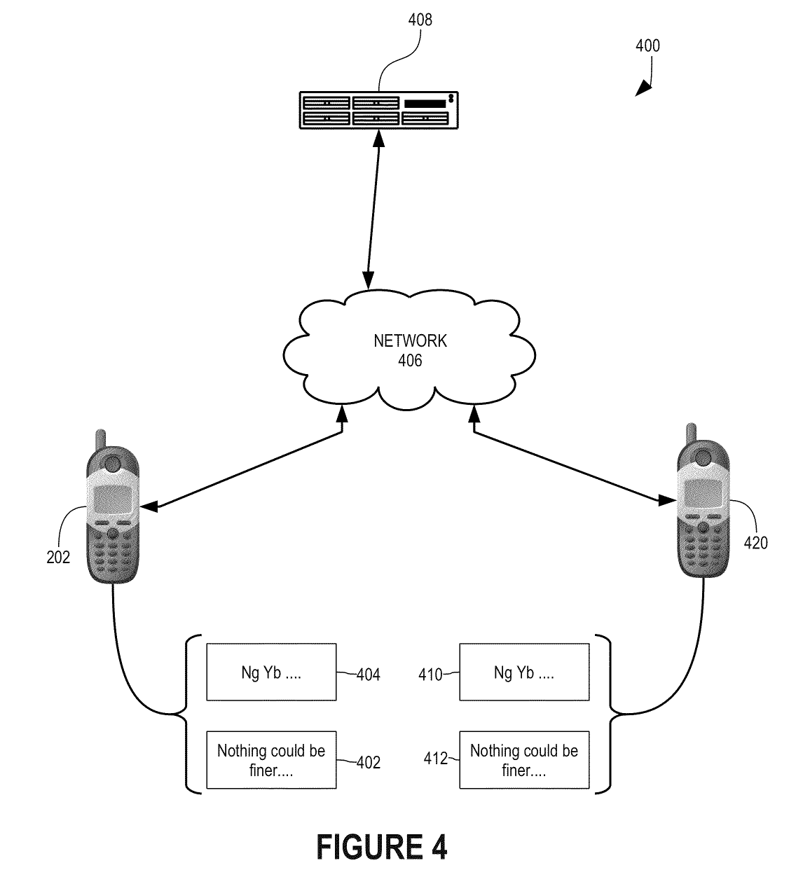

An overview of text encoding and decoding according to the present invention is shown in logic flow diagram 300 (FIG. 3). In step 304, text entry logic 112 (FIG. 1) receives signals generated by input device(s) 102 in response to physical manipulation by the user of keypad 210 (FIG. 2) of mobile phone 202 to enter a text message 402 (FIG. 4), e.g., “nothing could be finer than to meet you in the diner.” In step 306 (FIG. 3), text entry logic 112 receives a signal that indicates that message 402 (FIG. 4) is to be sent. The signal is generated by input device(s) 102 in response to the user physically pressing button 208 which selects soft key 206. In response, text entry logic 112 sends message 402 to encoding logic 118. In step 308 (FIG. 3), encoding logic 118 encodes message 402 (FIG. 4) to form an encoded message 404 in a manner described more completely below. Compression logic 118 (FIG. 1) returns encoded message 404 (FIG. 4) to text entry logic 112 (FIG. 1), and text entry logic 112 sends encoded message 404 through network 408 to a short message center 408 for delivery to an intended recipient according to the conventional SMS protocol in step 310 (FIG. 3).

It should be appreciated that, since encoded message 404 includes only characters that can be used in conventional SMS messages, encoded message 404 can travel through network 406 and short message center 408 without requiring any modification to network 406 or short message center 408. In tests using codes with no more than two characters (only about 7,300 codes representing only about 7,300 respective phrases expected to appear frequently in messages generally), SMS messages have been compressed at ratios of about 1.7:1. As a result, on average, message 402 can be 70% longer than the conventional maximum message length for SMS. In addition, SMS traffic through network 406 and short message center 408 is reduced by approximately 41%. In embodiments which permit larger code sets and dictionary sizes, even greater resource savings are possible.

The intended recipient is a mobile telephony device 420 (FIG. 4) that is directly analogous to mobile telephone 202. Short message center 408 forwards the encoded message through network 406 in step 312 (FIG. 3) and the intended recipient receives the encoded message as encoded message 410 (FIG. 4) in step 314 (FIG. 3). In step 316, decoding logic 120 (FIG. 1) executing in the intended recipient decompresses encoded message 410 (FIG. 4) to produce decoded message 412.

At this point, decoded message 412 is stored in the intended recipient as any conventional SMS message is stored once received. In step 318 (FIG. 3), the intended recipient device receives a signal that is generated by a user through physical manipulation of one or more input devices and that represents the user's request to view decoded message 412 (FIG. 4). In response thereto, the intended recipient device displays decoded message 412 in a display such as display 204 (FIG. 2) using character images 114 (FIG. 1).

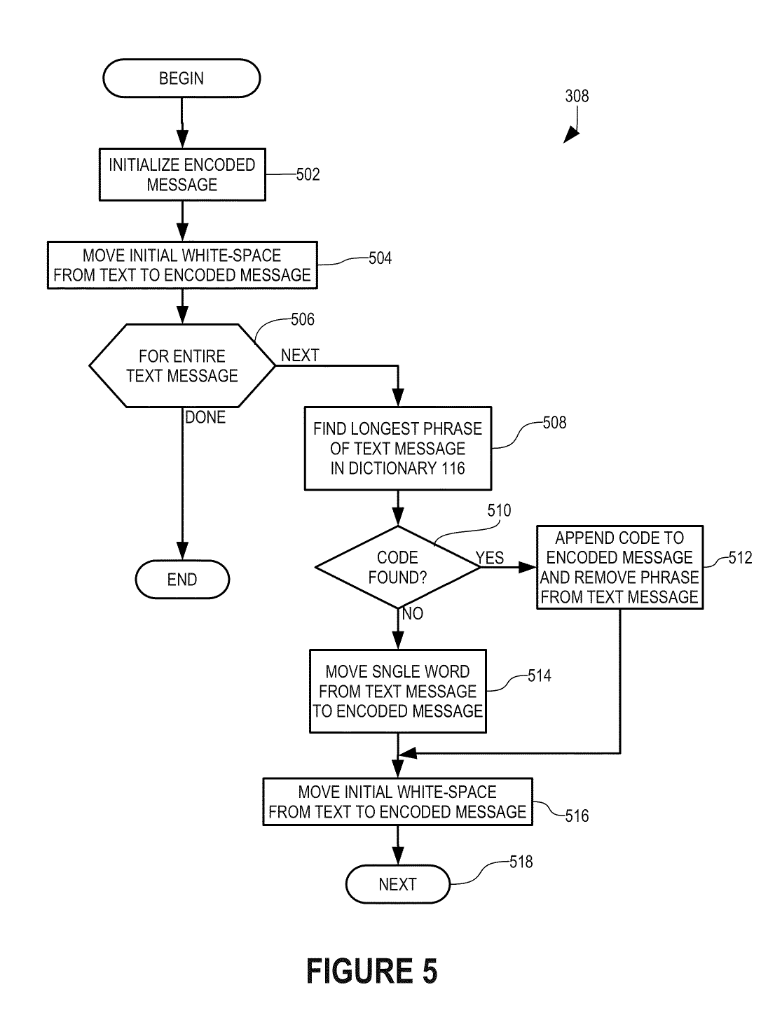

The encoding and decoding of the message “nothing could be finer than to meet you in the diner” serves as an illustrative example of text message 402. Step 308 is shown in greater detail as logic flow diagram 308 (FIG. 5).

In step 502, encoding logic 118 (FIG. 1) initializes encoded message 404 (FIG. 4) to be an empty string, i.e., a text string with zero characters. If the original text message is to be preserved, encoding logic 118 (FIG. 1) can also make a disposable copy of the original text message as characters are removed from the text message in logic flow diagram 308 as described below. Alternatively, encoding logic 118 can simulate removal of characters using pointers to offsets within the original text message. In the following description of logic flow diagram 308, text message 402 (FIG. 4) is disposable in that characters can be removed from text message 402, actually or virtually.

In step 504 (FIG. 5), encoding logic 118 (FIG. 1) moves any whitespace at the beginning of text message 402 (FIG. 4) to the end of encoded message 404. As used herein, “whitespace” includes any characters designated as non-word characters, including some punctuation for example. In this illustrative example of “nothing could be finer than to meet you in the diner,” there is no whitespace at the beginning of text message 402, so step 504 (FIG. 5) has no effect.

Loop step 506 and next step 518 define a loop in which encoding logic 118 performs steps 508-516 until no characters of text message 402 remain to be processed.

In step 508, encoding logic 118 finds the longest phrase at the beginning of text message 402 (FIG. 4) that is represented by a code in dictionary 116 (FIG. 1). Step 508 (FIG. 5) is described below in greater detail.

In test step 510, encoding logic 118 determines whether any code was found for a phrase at the beginning of text message 402 (94). If so, encoding logic 118 appends that code to encoded message 404 and removes the corresponding phrase from the beginning of text message 402 in step 512 (FIG. 5). For example, if encoding logic 118 finds a code for “nothing could be”, encoding logic 118 would append that code to encoded message 404 (FIG. 4) and remove “nothing could be” from the beginning of text message 402. It should be appreciated that the remainder of text message 402 would then begin with the space character between “be” and “finer.”

Conversely, if encoding logic 118 determines in test step 510 that no code of dictionary 116 represents any phrase at the beginning of text message 402, encoding logic moves a single word from the beginning of text message 402 to the end of encoded text 404 in step 514. It is possible that the single word is a legitimate code. For example, given that codes are strings of one or two or three word characters in this illustrative embodiment, any word that is not longer than three characters could be a legitimate code. In such a case, encoding logic 118 prepends a quotation flag to the word in encoded message 404 to distinguish the word from a code. For example, if dictionary 116 contains no code for “In” and text message 402 includes the word “In”, encoding logic 118 prepends a quotation flag—an apostrophe in this illustrative embodiment—to the word as appended to encoded message 404, i.e., “In”.

After either step 512 (FIG. 5) or step 514, processing by encoding logic 118 transfers to step 516 in which encoding logic 118 moves any leading whitespace from text message 402 to encoded message 404 in the manner described above with respect to step 504. Thus, encoding logic 118 preserves the space between “be” and “finer” by moving it to encoded text 404 in step 516.

Processing then transfers through next step 518 (FIG. 5) to loop step 506 in which another iteration of the loop of steps 506-518 is performed until text message 402 is empty. Thus, encoded text 404 is the result of replacing any phrases represented in dictionary 116 with codes associated therewith in dictionary 116 and otherwise preserving text message 402. No attempt is made to encode non-word characters except as embedded in phrases of more than a single word. In addition, words of text message 402 that are not otherwise encoded and that can be confused with codes of dictionary 116 are flagged with a quotation flag.

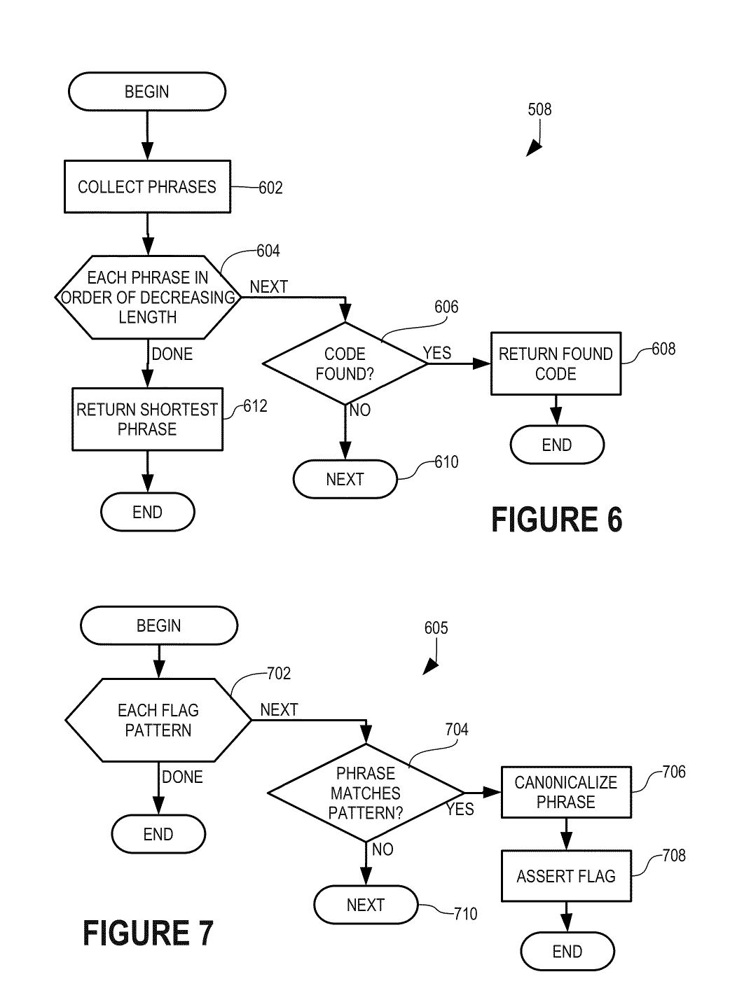

Step 508, in which a code for the longest of a number of phrases at the beginning of text message 402 is retrieved from dictionary 116, is shown in greater detail as logic flow diagram 508 (FIG. 6). In step 602, encoding logic 118 collects a number of phrases from the beginning of text message 402. In this illustrative embodiment, encoding logic 118 collects phrases of one, two, three, four, and five words. Phrases are arbitrarily limited to a maximum of five (5) words in this illustrative embodiment to keep text processing and database searching of encoding logic 118 sufficiently efficient to execute quickly on small computing devices such as mobile telephones. In other embodiments, encoding logic 118 can process even longer phrases.

Using the example text message, the phrases would be “nothing”, “nothing could”, “nothing could be”, “nothing could be finer”, and “nothing could be finer than”. Compression logic 118 preserves all whitespace embedded in the phrases. For example, if there were two spaces between “nothing” and “could”, encoding logic 118 includes both spaces between those words in the various phrases.

Loop step 604 (FIG. 6) and next step 610 define a loop in which encoding logic 118 processes the collected phrases according to steps 606-608 in order of decreasing length of the phrases. As a result, the phrases of the example text message listed above would be processed by encoding logic 118 in reverse order.

In test step 606, encoding logic 118 requests retrieval from dictionary 116 of a code representing the particular phrase being processed in the current iteration of the loop of steps 604-610, which is sometimes referred to as “the subject phrase” in the context of logic flow diagram 508. If a code is successfully retrieved from dictionary 116, logic flow diagram 508 returns the retrieved code in step 608 and that code is processed by encoding logic 118 in step 512 (FIG. 5) in the manner described above.

Conversely, if no code is successfully retrieved from dictionary 116 in test step 606, processing by encoding logic 118 transfers through next step 610 to loop step 604 in which the next longest phrase collected in step 602 is processed according to steps 606-608 in the manner described above.

Once all phrases collected by encoding logic 118 have been processed according to the loop of steps 604-610 and no iterations thereof cause early termination through step 608, processing transfers to step 612. In step 612, encoding logic 118 has determined that none of the phrases collected in step 602 are represented in dictionary 116 and therefore returns the shortest of the collected phrases, e.g., a single word in this illustrative embodiment, as the text to be appended to encoded text 404.

It should be appreciated that, by trying to maximize the length of phrases replaced by codes of dictionary 116, greater encoding ratios are realized. To use this illustrative example, it is preferable to replace “nothing could be” with a single code than “nothing” if “nothing could be” and “nothing” are both found in dictionary 116 as phrases that can be represented with a code.

In this illustrative embodiment, encoding logic 118 ensures that every character of text message 402 is represented in encoded message 404. This includes superfluous whitespace and character case and misspellings. To preserve these characteristics of text message 402, phrases represented in dictionary 116 are case-specific and whitespace-specific. As an example, consider the example text message, “Hi. My name is ‘Jim.’” In this illustrative example, spaces, periods, and apostrophes are non-word characters and therefore are considered “whitespace” by encoding logic 118. “Hi” would not be matched by “hi” and, to be represented in dictionary 116, would require a separate entry for “Hi” in dictionary 116 in this illustrative embodiment. Similarly, the phrase “Hi. My” would require an entry in dictionary 116 that matches case and includes exactly a period followed by two spaces between “Hi” and “My”.

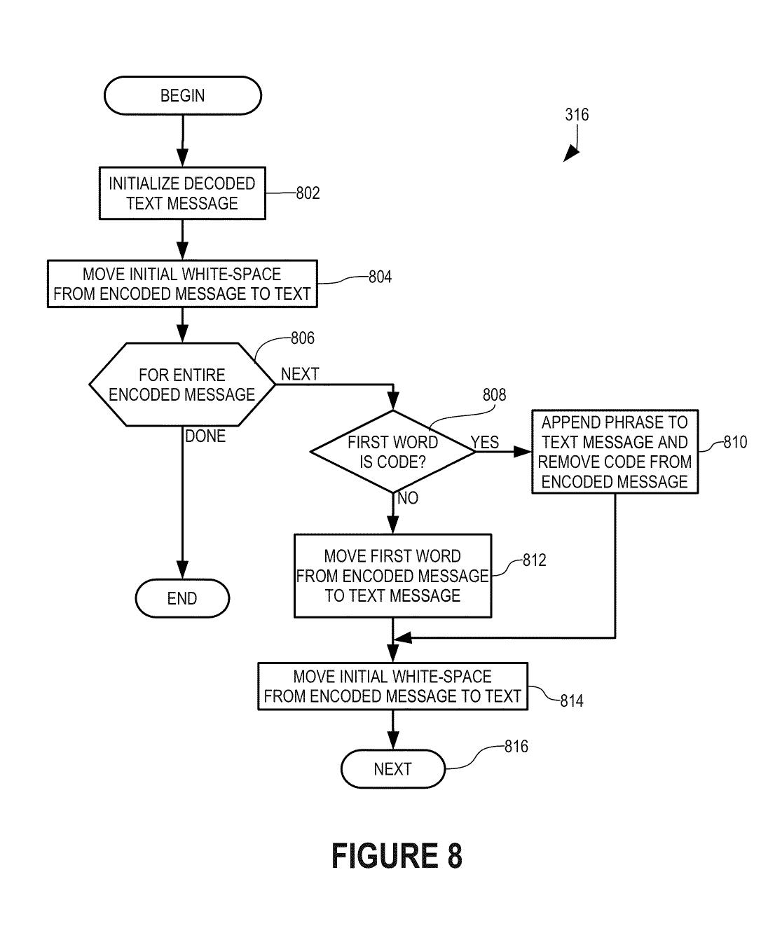

There are a number of variations that can ameliorate this problem of message variations, one of which is illustrated as logic flow diagram 605 (FIG. 7). In this illustrative embodiment, encoding logic 118 performs the steps of logic flow diagram 605 between loop step 604 (FIG. 6) and test step 606.

Loop step 702 (FIG. 7) and next step 710 define a loop in which encoding logic 118 processes each of a number of flag patterns according to steps 704-708. In this illustrative embodiment, two such flag patterns are implemented by encoding logic 118 as indicated in Table B above. One flag pattern corresponds to phrases in all uppercase characters and the other flag pattern corresponds to phrase in which only the first character of each word is not lowercase, i.e., is either uppercase or is not a letter.

In test step 704, encoding logic 118 determines whether the particular flag pattern being processed in the current iteration of the loop of steps 702-710, which is sometimes referred to in the context of logic flow diagram 605 as “the subject flag pattern,” matches the subject phrase. If not, processing by encoding logic transfers through next step 710 to loop step 702 and encoding logic 118 processes the next flag pattern.

Conversely, if the subject flag pattern matches the subject phrase, processing by encoding logic 118 transfers to step 706. In step 706, encoding logic 118 canonicalizes the subject phrase. In both the initial capitals and the all capitals flag patterns, the canonical form of the phrase is all lowercase. The phrase as canonicalized is used in test step 606 when retrieving a matching code from dictionary 116.

In step 708, encoding logic 118 asserts the flag of the subject flag pattern. Step 608 (FIG. 6) is modified in this embodiment such that any asserted flag is prepended to the returned code. After step 708, processing according to logic flow diagram 605 completes such that no more than a single flag is applied to any given phrase.

If no flag pattern matches the subject phrase, processing by encoding logic 118 according to logic flow diagram 605 neither modifies the subject phrase nor asserts any flag as neither step 706 nor step 708 is performed for the subject phrase.

Thus, with little added payload of the occasional flag character, a single entry in dictionary 116 can represent a number of variations of phrases. For example, consider that the code, “Ng”, represents “nothing could be” in dictionary 116. The flagged code, “_Ng”, represents “Nothing Could Be”, and the flagged code, “̂Ng”, represents “NOTHING COULD BE”.

In another variation that can ameliorate this problem of message variations is canonicalization of whitespace. Consider the example in which text message 402 includes two spaces between “nothing” and “could”. In this illustrative alternative embodiment, once encoding logic 118 has determined that “nothing could be” (with two spaces between “nothing” and “could”) is not represented within dictionary 116, encoding logic 118 recognizes the double space characters within the phrase and searches dictionary 116 for the same phrase with only single space characters between words. In this example, encoding logic 118 finds such a phrase with whitespace therein so canonicalized. Compression logic 118 assumes that the phrase found in dictionary 116 is the phrase intended by the author of text message 402 (FIG. 4) and substitutes the phrase with the code associated with the whitespace-canonicalized variation of the phrase within dictionary 116.

When decoding logic 120 decodes a message encoded in this manner, the double space characters are not restored between “nothing” and “could.” Accordingly, this form of text compression is lossy. However, this very limited sort of lossiness in text compression can be acceptable in some contexts, particularly informal contexts such as text messaging between mobile telephony devices.

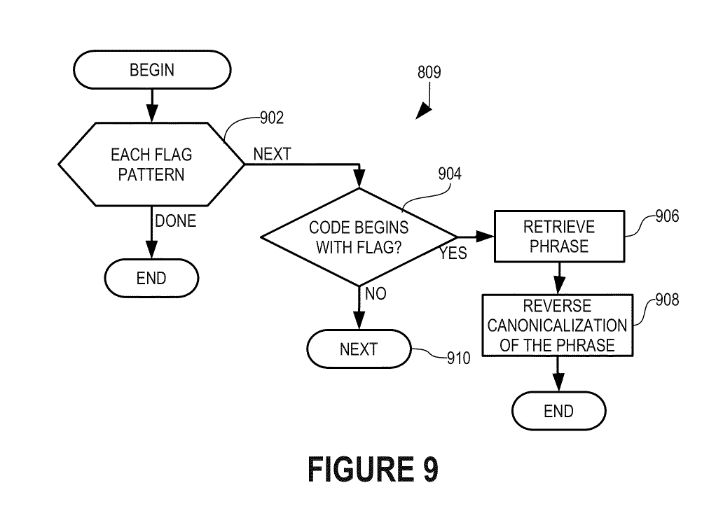

As described above, decoding logic 120 (FIG. 1) reconstructs text message 412 (FIG. 4) from encoded message 410, which is a copy of encoded message 404 received from mobile telephone 202 through short message center 408, in step 316 (FIG. 3). Step 316 is shown in greater detail as logic flow diagram 316 (FIG. 8).

In step 802, decoding logic 120 initializes decoded message 412 to be an empty text string. In addition, decoding logic 120 makes a disposable copy of encoded message 410 if encoded message 410 is to be preserved. Alternatively, decoding logic 120 can use pointers to simulate removal of characters from encoded message 410.

In step 804, (FIG. 8) decoding logic 120 moves any whitespace at the beginning of encoded text 410 to decoded message 412 in the manner described above with respect to step 504 (FIG. 5).

Loop step 806 (FIG. 8) and next step 816 define a loop in which decoding logic 120 processes the entirety of encoded message 410 according to steps 808-814.

In test step 808 (FIG. 8), decoding logic 120 determines whether the first word of encoded message 410 is a code. If the first word of encoded message 410 is legitimate code and is not prefixed with a quotation flag, the first word of encoded message 410 is determined to be a code and processing by decoding logic 120 transfers to step 810.

In step 810 (FIG. 8), decoding logic 120 retrieves the phrase associated with the code from dictionary 116 and appends the phrase to decoded message 412 and removes the code from encoded message 410.

Conversely, if the first word of encoded message 410 is not a code, processing by decoding logic 120 transfers from test step 808 (FIG. 8) to step 812. In step 812, decoding logic 120 moves the first word from the beginning of encoded message 410 to the end of decoded message 412, stripping any quotation flag found at the beginning of the word if the word could otherwise be confused with a legitimate code.

After either step 810 (FIG. 8) or step 812, processing transfers to step 814 in which decoding logic 120 moves any whitespace at the beginning of encoded message 410 to the end of decoded message 412.

Processing transfers through next step 816 (FIG. 8) to loop step 806 in which decoding logic 120 continues processing of encoded message 410 according to steps 808-814 until all of encoded message 410 has been processed.

Upon completion of processing of encoded message 410 according to the loop of steps 806-816 (FIG. 8), decoding logic 120 has reconstructed decoded message 412 as a true and correct copy of text message 402.

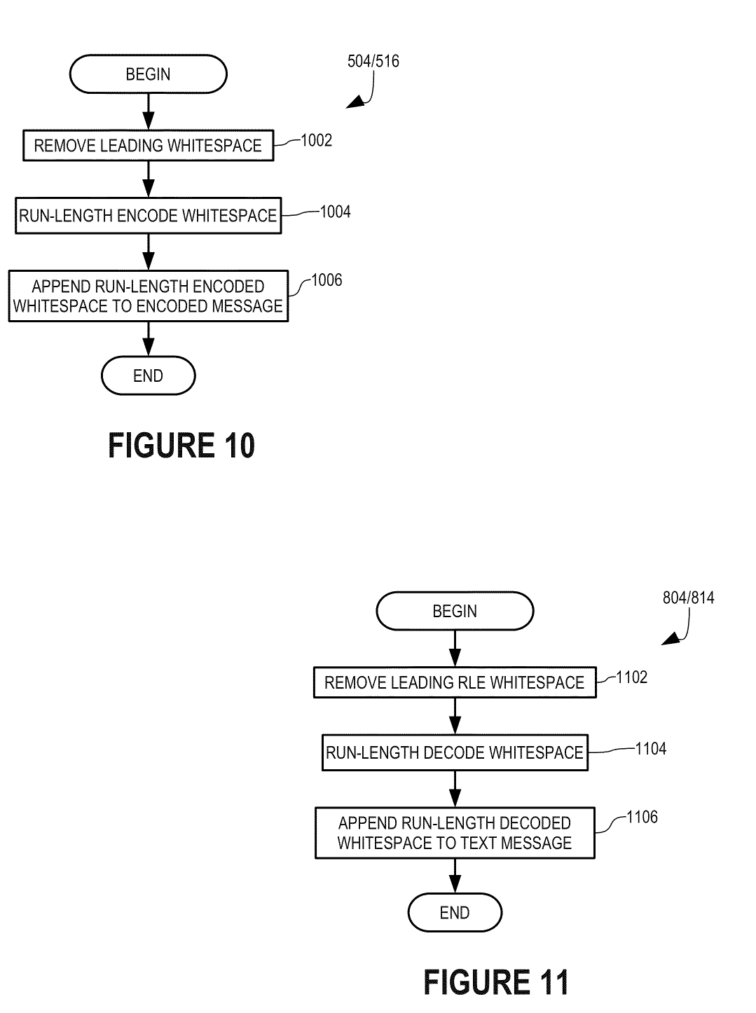

To properly decode codes prefixed with flags in the manner described above with respect to logic flow diagram 605 (FIG. 7), decoding logic 120 performs the steps of logic flow diagram 809 (FIG. 9) between test step 808 and step 810 upon a determination that the first word of encoded message 410 is a legitimate code. In the context of logic flow diagram 809 (FIG. 9), the code that is the first word of encoded message 410 is sometimes referred to as “the subject code.”

Loop step 902 (FIG. 9) and next step 910 define a loop in which decoding logic 120 processes each flag pattern implemented by encoding logic 118 and decoding logic 120. In this illustrative embodiment, an initial capital pattern and an all capital pattern are implemented. In the context of each iteration of the loop of steps 902-910, the particular flag pattern processed during that iteration is sometimes referred to as “the subject flag pattern.”

In test step 904 (FIG. 9), decoding logic 120 determines whether the subject code begins with the flag character associated with the subject flag pattern. In not, processing by decoding logic 120 transfers through next step 910 to loop step 902 and the next flag pattern is processed according to the loop of steps 902-910. Conversely, if the subject code begins with the flag associated with the subject flag pattern, processing transfers from test step 904 to step 906.

In step 906 (FIG. 9), decoding logic 120 retrieves the phrase associated with the subject code from within dictionary 116 after removing the flag from the beginning of the subject code. In step 908, decoding logic 120 reverses the canonicalization of the phrase to restore the original phrase. After step 908, processing by decoding logic 120 according to logic flow diagram 809 completes. Thus, only a single flag can be processed in this illustrative embodiment. This is because initial capitals and all capitals are mutually exclusive states. In other embodiments, codes can have multiple flags.

Continuing in the examples above, processing of the flagged code, “_Ng”, by decoding logic 120 according to logic flow diagram 809 results in recognition by decoding logic 120 of “_” as an initial capital flag in test step 904; retrieval of “nothing could be” from dictionary 116 using the code, “Ng”, in step 906; and restoration of the initial capitalization in step 908 to reconstruct “Nothing Could Be” as the represented text.

As described above, whitespace (any non-word characters) that is not embedded within a phrase is not encoded and is, instead, included in encoded messages 404 (FIG. 4) and 410 in its original form. There are sometimes messages that defy substantial compression by including an unusual amount of whitespace. For example, many people send text messages in which punctuation is repeated for emphasis. Simple examples include “NO!!!!!!!!!!!”, “YES!!!!!!!!!”, and “WHAT???????”

Improved compression rates can be realized in some embodiments by run-length encoding whitespace. In particular, typical non-word characters tend not to appear in long strings without long strings of a single, repeated non-word character. As a result, run-length encoding can be an effective tool in mitigating the otherwise incompressibility of whitespace in techniques described herein.

Run-length encoding is well-known and is not described herein except in the context of an illustrative embodiment for run-length encoding whitespace by encoding logic 118 and decoding logic 120.

First, it should be appreciated that there is no need to run-length encode whitespace within a phrase already represented in dictionary 116. Suppose, for example, that “wait . . . for . . . just . . . one . . . minute” appeared to frequently in text messages that the phrase is represented in dictionary 116 and associate with a code of 1-3 characters in length. That code would represent the entirety of the phrase, including the four (4) strings of five (5) periods. Accordingly, there would be virtually no incentive to use run-length encoding within phrases stored in dictionary 116. One possible exception might be to reduce the size of dictionary 116 itself by compressing phrases stored therein. However, strings of repeated characters tend to appear in text so rarely as to be unlikely to significantly reduce the size of dictionary 116.

Thus, excluding whitespace embedded in encoded phrases, whitespace is handled by encoding logic 118 only in steps 504 (FIG. 5) and 516 and by decoding logic 120 only in steps 804 (FIG. 8) and 814.

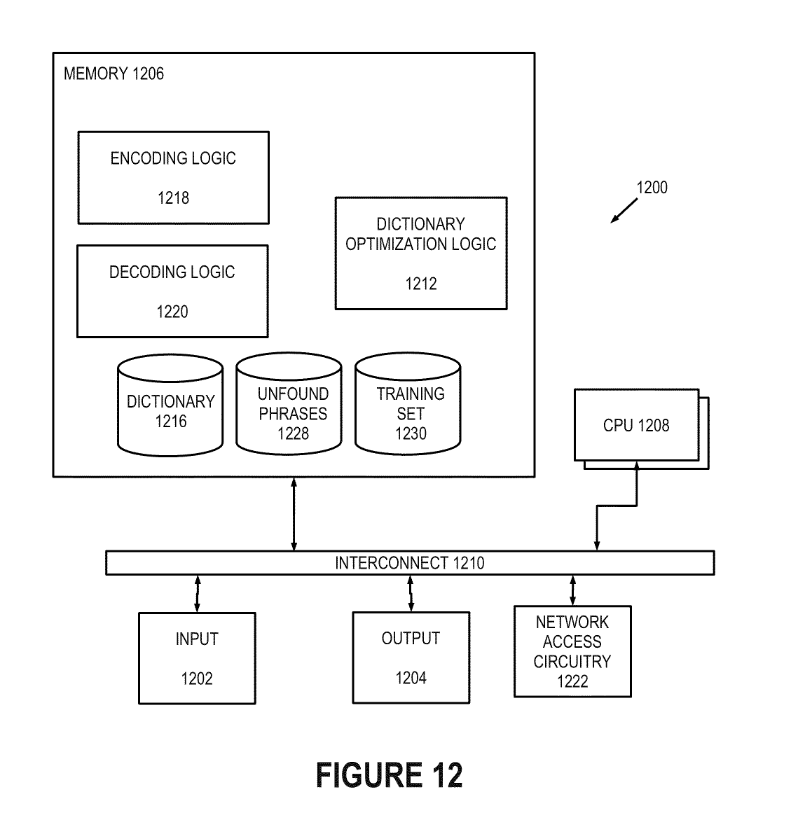

Steps 504 (FIG. 5) and 516 are shown in greater detail as logic flow diagram 504/516 (FIG. 10). In step 1002, encoding logic 118 removes the leading whitespace from text message 402. In step 1004, encoding logic 118 run-length encodes the whitespace and, in step 1006, appends the run-length encoded whitespace to encoded message 404.

Run-length encoding by encoding logic 118 in step 1004 deviates from conventional run-length encoding. For example, encoding logic 118 excludes at least one non-word character at the end of the whitespace from run-length encoding such that the trailing non-word character delimits the next word in text message 402. Consider the example text, “Wait . . . 20 minutes.” The six (6) periods could be run-length encoded as “0.6” but that would result in “Wait.620 minutes.” But, since numerals are word-characters, it would not be entirely clear whether that should be decoded as six (6) periods followed by “20 minutes”, sixty-two (62) periods followed by “0 minutes”, or six hundred and twenty (620) periods followed by “minutes.” Conversely, “Wait.5.20 minutes.” is more easily recognizable as the first interpretation.

However, such is not the end of the ambiguity. A message like “Wait.5.minutes.” can be the result of run-length encoding the periods of “Wait . . . minutes.” or can be the result of obviated run-length encoding of “Wait.5.minutes.” Visible punctuation is used in this examples to assist the reader in following the examples where counting non-visible non-word characters (e.g., a space character) would be a challenge.

To remove such ambiguity, encoding logic 118 treats a word that includes only numerals as one that requires a quotation flag prefix. Accordingly, encoding “Wait.5.minutes.” would result in the word, “5”, being prefixed with an apostrophe quotation flag whereas encoding “Wait . . . minutes.” would result in the run-length encoded six (6) periods being represented as “0.5.”, i.e., without the apostrophe quotation flag prefix on “5”.

In addition, there is no size reduction in run-length encoding a string of fewer than 4 repeated non-word characters. For example, “.” couldn't be run-length encoded as there is no additional non-word character to follow the run-length encoded whitespace; “ . . . ” would require an additional character to run-length encode as “0.1.”; and “ . . . ” would require the same number of characters to run-length encode as “0.2.”. In addition, “0.0.” would be meaningless as a run-length encoded string in this embodiment. Accordingly, the words “0”, “1”, and “2” would require no quotation flag as they would not appear in run-length encoded whitespace.

Steps 804 (FIG. 8) and 814 are shown in greater detail as logic flow diagram 804/814 (FIG. 11). In step 1102, decoding logic 120 removes the leading, run-length encoded (RLE) whitespace from encoded message 410. In step 1104, decoding logic 120 run-length decodes the RLE whitespace, restoring the strings of repeated non-word characters of the lengths specified in the RLE whitespace. In step 1106, decoding logic 120 appends the run-length decoded whitespace to decoded message 412.

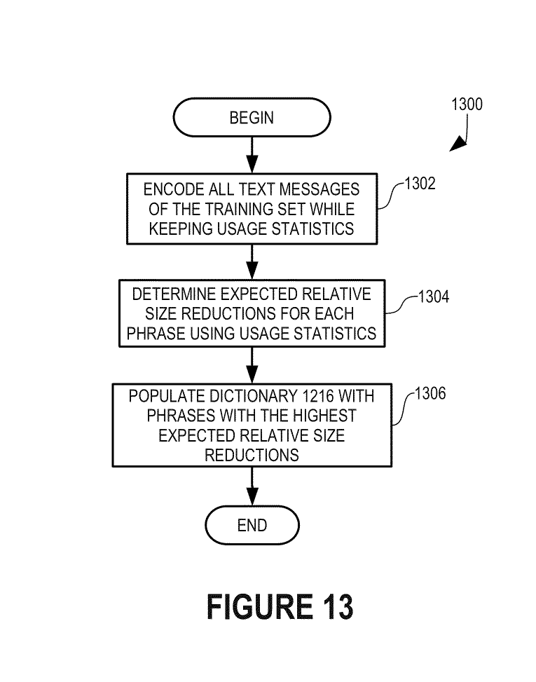

In this illustrative messaging embodiment, dictionary 116 is populated using a training set 1230 (FIG. 12) of text messages. Training set 1230 of text messages should be representative of the text messages intended to be compressed. In addition, training set 1220 should have a sufficiently large population to relatively finely distinguish frequency of usage of many phrases and to avoid short-lived popular trends in text messages.

This population of dictionary 116 is performed using dictionary optimization logic 1212 which is generally not needed in the encoding and decoding of messages in the manner described above. Accordingly, optimization logic 1212 is shown to be included in a different computer system 1200, such as a computer used in the development and implementation of encoding logic 118 and decoding logic 120.

Most of the components of computer 1200 are directly analogous to components of computer 100 (FIG. 1) as described above. In particular, computer 1200 (FIG. 12) includes input device(s) 1202, output device(s) 1204, memory 1206, CPU 1208, interconnect 1210, and network access circuitry 1222 which are each respectively directly analogous to device(s) 102 (FIG. 1), output device(s) 104, memory 106, CPU 108, interconnect 110, and netword access circuitry 122 of computer 100. Compression logic 1218, decoding logic 1220, and dictionary 1216 are directly analogous to encoding logic 118, decoding logic 120, and dictionary 116 except as noted below.

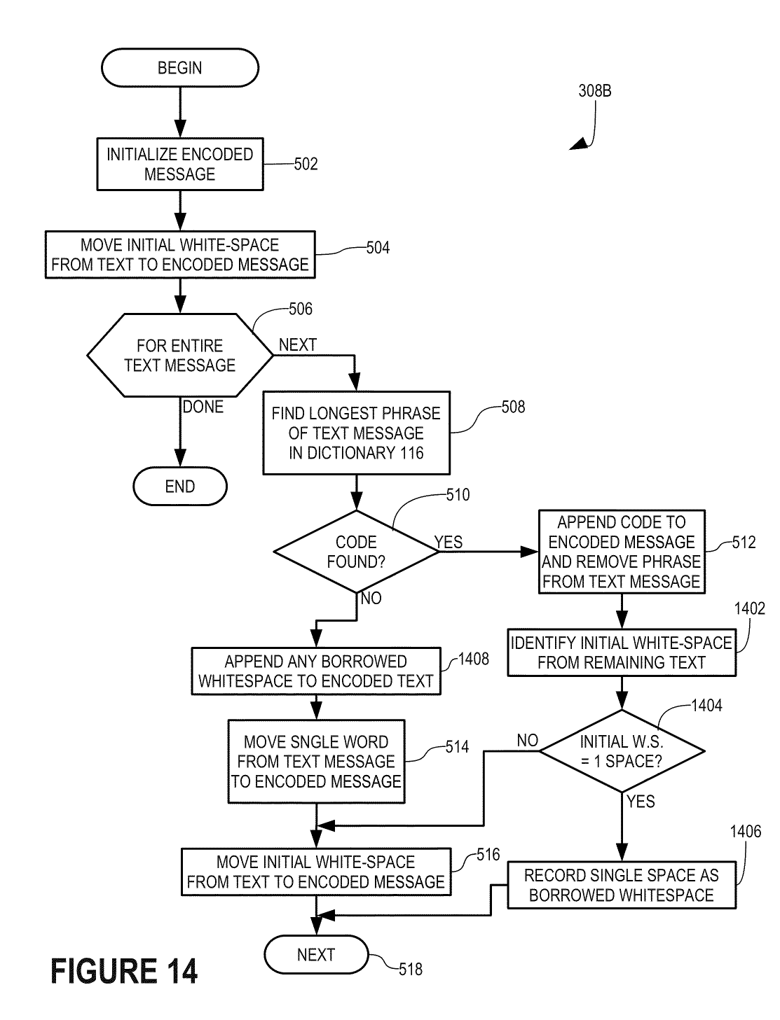

Logic flow diagram 1300 (FIG. 13) illustrates the populating of dictionary 1216 by dictionary optimization logic 1212 for subsequent population of dictionary 116. In step 1302, dictionary optimization logic 1212 (FIG. 12) causes encoding logic 1218 to compress all text messages of training set 1220 by encoding them in the manner described above while collecting usage statistics in the manner described below. Prior to such encoding, dictionary 1216 can be populated with a predetermined set of phrases subjectively expected to be frequently used in the estimation of human designers of dictionary 1216. During such encoding, encoding logic 1218 records the number of times each entry in dictionary 1216 is used. In addition, encoding logic 1218 records phrases not represented in dictionary 1216 in an unfound phrases database 1228 and records therein the number of times each phrase is used. Such phrases can be represented in a table in dictionary 1216 or, as shown in this illustrative embodiment, in a separate database, for example.

In the example given above with respect to logic flow diagram 308 (FIG. 5), encoding logic 1218 (FIG. 12) searches for entries in dictionary 1216 for “nothing could be finer than”, “nothing could be finer”, “nothing could be”, “nothing could”, and “nothing” in that order. It should be appreciated that, as in the example described above, it's possible that shorter phrases are not counted as used. For example, if “nothing could be” is found in dictionary 1216, the phrases “nothing could” and “nothing” are not searched and therefore not counted. This reflects that, due to representation of the phrase, “nothing could be”, in dictionary 1216 obviates representation of the shorter phrases for this particular portion of this text message. Accordingly, it's possible that some of the most commonly used words are not represented in dictionary 1216 if those words very often appear in phrases that are already represented in dictionary 1216.

Once encoding logic 1218 has encoded and compressed the text messages of training set 1230, dictionary 1216 contains usage statistics for all phrases represented in dictionary 1216 and unfound phrases database 1228 contains usage statistics for all phrases searched for without success in dictionary 1216.

In step 1304 (FIG. 13), dictionary optimization logic 1212 (FIG. 12) determines expected relative size reductions for each phrase represented in dictionary 1216 and unfound phrase database 1228. Expected relative size reductions for the phrases serve as respective relative priorities of the phrases for inclusion in dictionary 1216.

This expected relative size reduction is the size reduction realized for each substitution of the subject phrase with a code representing it. This difference is sometimes referred to as a “single-use reduction” and takes into consideration the use of quotation flags if necessary and the length of the code. For example, a single-use reduction for “be” if represented by a single-character code is two (2)—three (3) (the length of “be” prefixed with a quotation flag) less one (1) (the length of the single-character code). Similarly, the single-use reduction for “nothing could be” if represented by a two-character code is fourteen (14)—the length of “nothing could be” (16) less the length of the two-character code (2).

To determine a phrase's expected relative size reduction, the phrase's single-use reduction is multiplied by the number of times the phrase appeared in the text messages of training set 1228.

In step 1306 (FIG. 13), dictionary optimization logic 1212 populates dictionary 1216 with those phrases of dictionary 1216 and unfound phrase database 1228 with the highest expected relative size reduction.

After step 1306, dictionary 1216 includes in its limited number of entries those phrases most likely to provide greatest rates of data encoding when used to encode messages of a type modeled by training set 1230. This population of dictionary 1216 can be repeated as new statistics become available or can be repeated as training set 1230 is updated to periodically fine-tune dictionary 1216.

The entries of dictionary 1216, less the statistics, are included in dictionary 116 (FIG. 1) to provide effective and efficient encoding in the manner described above.

It should be appreciated that dictionary optimization logic 1212 determines expected relative size reduction in a way that favors greatest encoding ratios over large numbers of text messages. In particular, some very long phrases are used just frequently enough to represent greater aggregate data reduction than far more frequently used short phrases. As a result, text messages encoded in the manner described above with dictionaries populated in this manner may often be compressed only slightly or not at all, while other messages are compressed to a much larger extent and often enough to reduce overall data sizes of messages in aggregate.

In other embodiments, it may be preferable to maximize reduction of each message such that senders can include more information in each message despite a hard limit on the maximum size of a message. In such embodiments, other expected relative size reductions, or “value” within a encoding model, of each phrase can be determined and compared for determining which phrases are included in the limited number of entries in dictionary 1216.

In such embodiments, expected relative size reduction is not linear with respect to usage but can be exponentially related to usage, for example. In one embodiment, expected relative size reduction is determined as the single-use reduction multiplied by usage frequency of the subject phrase raised to a power greater than one (1.3, for example). To increase the effect of usage frequency of a phrase relative to the phrase's single-use reduction, higher exponents are used. And, conversely, to increase the effect of a phrase's single-use reduction relative to the phrase's usage frequency, lower exponents are used.

As described above, dictionary 116 does not include usage statistics in the illustrative embodiment. In other embodiments, dictionary 116 does include such usage statistics maintained by encoding logic 118 in the manner described with respect to encoding logic 1218, except that encoding logic 118 also records the total number of messages encoded for normalization of usage statistics relative to other instances of encoding logic 118. In such an embodiment, encoding logic 118 is configured to periodically report usage statistics to dictionary optimization logic 1212 for subsequent use in improving dictionary 1216 in the manner described above with respect to steps 1304 and 1306.

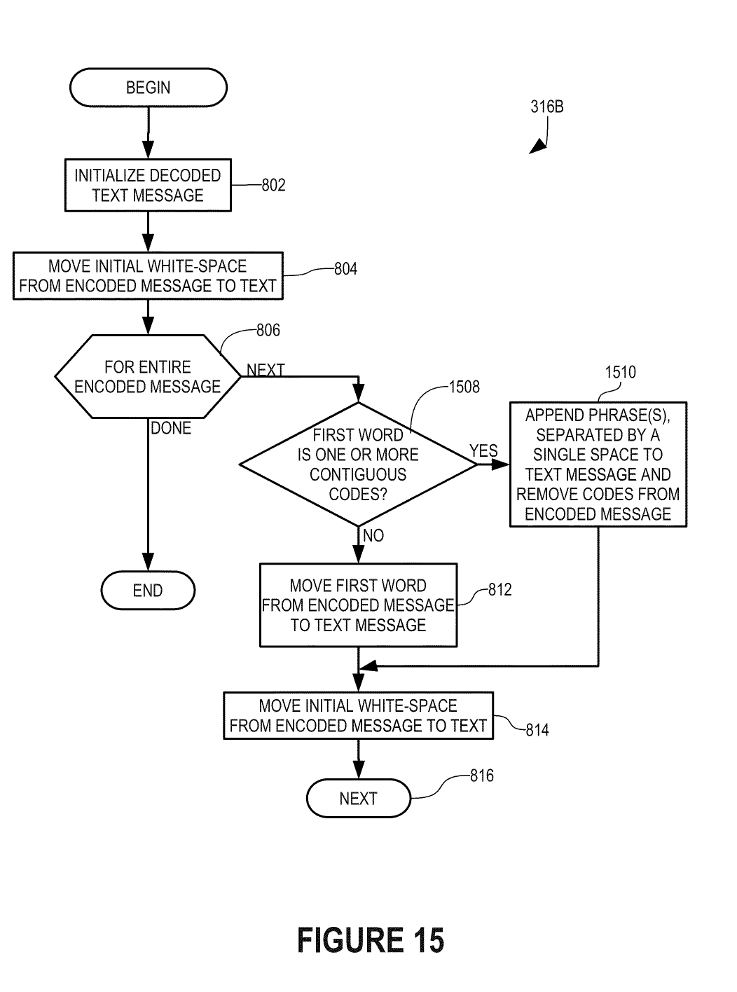

Even more efficient compression can be realized by recognizing that most whitespace between words and phrases in text message consists of a single space character and making such a space character merely implicit in encoded text. This embodiment is represented by logic flow diagrams 308B (FIG. 14) and 316B (FIG. 15), which are alternatives to logic flow diagrams 308 (FIG. 5) and 316 (FIG. 8), respectively.

To start, word characters are divided into mutually exclusive sets of initial code characters and subsequent code characters. Initial code characters can only be the first character of a code and subsequent code characters can only be a second or subsequent character of a code. Generally, in this embodiment, the total number of codes that can be represented with a given maximum number of characters is maximized when word characters are nearly evenly divided between initial code characters and subsequent code characters.

Since only about half of all word characters are used in this embodiment as initial code characters, only about half as many single-character codes are available relative to embodiments such as those described above in which whitespace is preserved between codes. Similarly, the number of 2- and 3-character codes that are available are similarly dramatically reduced. However, since much of the whitespace between codes can be omitted from encoded text, 2-character codes occupy as much of encoded text as single-character codes in embodiments in which the single-space character between codes is preserved. Thus, it is currently believed that the embodiment described in conjunction with FIGS. 14 and 15 will always provide better compression than embodiments such as those described above.

When space characters between codes are omitted, the start of a code is recognized as an initial code character that is optionally preceded by a flag. Accordingly, flags are excluded from the set of subsequent code characters. However, flags that apply to unencoded phrases and not to codes (such as the quotation flag) can be included in the set of subsequent code characters.

Logic flow diagram 308B (FIG. 14) illustrates encoding of a body of text in accordance with this alternative embodiment. Steps of logic flow diagram 308B are directly analogous to similarly numbered steps of logic flow diagram 308 (FIG. 5). Only steps of logic flow diagram 308B that differ from logic flow diagram 308 are described hereafter.

In step 1402 (FIG. 14), encoding logic 118 (FIG. 1) identifies leading whitespace of text message 402. In test step 1404, encoding logic 118 determines whether the leading whitespace is a single space character. It should be appreciated that steps 1402-1404 are only reached when the most recently processed text of text message 402 is represented in encoded text 404 by a code. Thus, test step 1404 effectively determines whether a code is separated from the following phrase by a single space character.

If the leading whitespace is not a single space character, processing transfers to step 516 in which the leading whitespace is moved to encoded message 404 in the manner described above. Thus, any whitespace other than a single space character is not omitted between codes. Conversely, if the leading whitespace is a single space character, processing transfers to step 1406.

In step 1406, encoding logic 118 (FIG. 1) records a single space character as borrowed whitespace, i.e., as whitespace that must be accounted for in some way. After step 1406, processing transfers through next step 518 to the next iteration of the loop of steps 506-514.

Thus, after processing of a code that represents a phrase of text message 402, a single space character separating the code from the following phrase is not immediately copied to encoded text 404 but is instead remembered for subsequent processing. If the next phrase is represented by a code, processing of that phrase includes steps 512, 1402, 1404, and 1406, and the single space character is omitted from encoded text 404. The result is that contiguous codes are not separated by single space characters. Such separation is implicit only.

When a phrase of message text 402 is not represented by a code, processing transfers from test step 510 to step 1408. In step 1408, encoding logic 118 (FIG. 1) appends any borrowed whitespace encoded text 404. Accordingly, a single space character continues to separate a code from a following unencoded phrase in encoded text 404. In step 1408, encoding logic 118 (FIG. 1) also clears any recorded borrowed whitespace such that no extra space characters will be added in subsequent performances of step 1408 unless new borrowed whitespace is recorded in an intervening performance of step 1406.

After step 1406, processing transfers to step 514, and encoding logic 118 (FIG. 1) move the unencoded word from text message 402 to encoded text 404 in the manner described above. However, since codes can now appear in encoded text 404 as long strings of contiguous word characters without any intervening non-word characters, all unencoded words are preceded by the quotation flag, regardless of length.

The result is that, in encoded text 404, adjacent codes for phrases that were separated by a single space character in message text 402 are represented contiguously. The adjacent codes are separated from any unencoded text preceding or following the codes by any whitespace found in message text 402, including single space characters.

Logic flow diagram 316B (FIG. 15) illustrates decoding of a body of encoded text in accordance with this alternative embodiment. Steps of logic flow diagram 316B are directly analogous to similarly numbered steps of logic flow diagram 316 (FIG. 8). Only steps of logic flow diagram 316B that differ from logic flow diagram 316 are described hereafter.

In test step 1508, encoding logic 118 (FIG. 1) determines whether the first word of encoded text 410 is one or more contiguous codes. Since all unencoded words are identified as such with a quotation flag prefix, the absence of such a flag can be used to identify an unflagged string of word characters as one or more contiguous codes. However, a string of one or more contiguous codes is also recognizable as one or more contiguous instances of the following pattern: zero or more flag characters followed by exactly one initial code character followed by zero or more subsequent code characters. This recognition of where one code ends and another starts is made possible by the mutually exclusive designation of word characters as either an initial code character or a subsequent code character.

If the first word of encoded text 410 is not a string of one or more contiguous codes, processing by encoding logic 118 (FIG. 1) transfers to step 812 in which encoding logic 118 (FIG. 1) moves the first word of encoded text 410 to decoded message 412 in the manner described above, including removal of any quotation flag prefix.

Conversely, if the first word of encoded text 410 is a string of one or more contiguous codes, processing transfers from test step 1508 to step 1510. In step 1510, encoding logic 118 (FIG. 1) retrieves the respective phrases of the contiguous codes and appends those phrases, in sequence, to decoded message 412 separated by single space characters.

Thus, omitting implicit single-space whitespace between adjacent codes achieves better compression ratios and further obfuscates text messages. It should be appreciated that the predetermined initial code characters represent a marker of one end of the code. While this marker is described herein to be at the beginning of a code, it should be appreciated that the marker could be at the end of a token such that a token is zero or more subsequent code characters followed by an initial code character and can be recognized as such during decoding. In addition, the marker is not limited to a single character of a predetermined set of code characters. Predetermined sequences of two or more code characters can be used as markers. Such markers are distinguishable from non-marker portions of codes if the predetermined sequences used as codes are not used in non-marker portions of codes.

In an alternative embodiment, the phrases in dictionary 116 are each preceded by a predetermined whitespace character such as a space, as though each phrase began not with a letter or number, but with a space. Storing the phrases in the dictionary as though each phrase began with a space means that there will be no spaces preceding codes in the encoded text since each code exactly replaces the phrase which it represents, including the first character which, in the predetermined dictionary of this alternative embodiment, is a space character. As a result, it is neither necessary to exclude the space preceding a code when inserting the code in the encoded text, nor, on decoding, to restore the space. Characters in the text that are not preceded by a space character but otherwise match a dictionary entry are given the same code as the entry preceded by a space, but are flagged so that the assumed space is not shown upon decompression. Alternatively, phrases in dictionary 116 include a trailing space character to similarly include inter-phrase space characters in codes of the respective phrases.

Phrases stored in dictionary 116 are generally independent of the respectively associated codes, so long as the code-phrase associations are consistent between encoders and decoders of the same messages. In the example noted above, “nothing could be” is associated with the code “Ng” in dictionary 116. In another embodiment, some other code, e.g., “Gn”, can be associated with “nothing could be” in dictionary 116. Exploitation of this feature can be used to provide a significant degree of privacy.

It should be observed that, since most of the text of encoded messages 404 and 410 are represented by codes that bear no substantive relation to the represented text, encoded messages 404 and 410 are difficult (if not impossible) for human readers to parse and understand. However, it is possible that some portions of encoded messages 404 and 410 are quoted, unencoded words. But, with the great majority of encoded messages 404 and 410 being codes, a substantial degree of privacy is provided even with a dictionary of modest size.

If a group of human users would like an even greater degree of privacy from the rest of the world, they can use a larger dictionary or replace a universally used dictionary 116 with an analogous dictionary in which the codes associated with respective phrases have been randomly shuffled. Such a dictionary would allow encoding and decoding of messages within the group using this dictionary; however, messages encoded using dictionary 116 could not be decoded with this replacement dictionary, and messages encoded using this replacement dictionary could not be decoded using dictionary 116. Messaging using the shuffled dictionary is restricted to those using the shuffled dictionary.

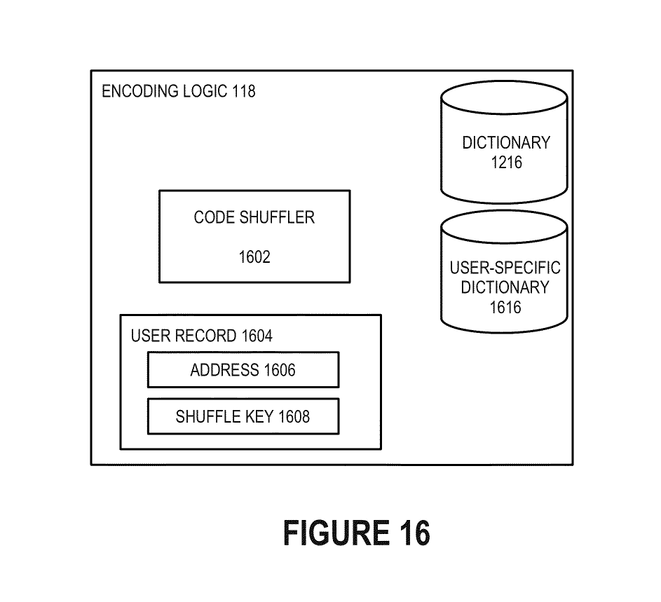

Privacy can also be provided on an individual user basis. FIG. 16 illustrates customized, user-specific, code shuffling that provides privacy for users while still allowing the users to communicate with each other.

Encoding logic 118 (FIG. 1 and FIG. 16) includes a code shuffler 1602 (FIG. 16) that maps codes used in dictionary 116 to codes used in a user-specific dictionary 1616. Code shuffler uses a shuffle key 1608 of a user record 1604 representing the recipient of the subject message. The recipient is identified by an address used for delivery of the subject message and represented as address 1606 of user record 1604.

Shuffle key 1608 determines to which respective codes of user-specific dictionary 1616 correspond to each code of dictionary 116. In one embodiment, shuffle key 1608 provides a complete mapping of the codes. In an alternative embodiment, shuffle key 1608 is a seed for a pseudo-random number generator which shuffles the codes of dictionary 116 in a deterministic, pseudo-random manner.

In encoding a message for the user represented by user record 1604, encoding logic 108—in step 608 (FIG. 6)—returns a user-specific code to which the code found in step 606 maps in code shuffler 1602 (FIG. 16). Accordingly, user-specific dictionary 1616 will properly decode the phrase using the substituted code from code shuffler 1602.

In decoding a message from the same user, decoding logic (FIGS. 1 and 16) employs an inverse code shuffler 1610 that provides the inverse of the mapping provided by code shuffler 1610. This inverse mapping is performed in step 810 to translate the code from user-specific dictionary 1616 to a code from dictionary 116 to thereby retrieve the proper phrase from dictionary 116.

### Using Non-ASCII Characters to Supplement ASCII, Thereby Increasing the Number of Codes in the Compression Dictionary

Another embodiment of the invention takes advantage of the fact that, while characters of the ASCII character set are used as code characters in the illustrative embodiment heretofore discussed in detail, any of one or more character sets other than ASCII—including Chinese, Japanese and/or Korean characters—can be used as code characters for encoding any language, including the encoding of English or other alphabetic or non-alphabetic languages, assuming only that the network over which the message is to be transmitted will transmit the character set used for code characters.

In an embodiment where the network used for transmission will transmit both ASCII characters and non-ASCII characters and where the non-ASCII characters require more than a single byte, the use of these multi-byte characters for encoding increases the available number of two-byte codes and three-byte codes used in dictionary 116, thereby improving compression. For example if the character “A”, which is transmissible over a network using the GSM 03.38 character set (in which it is assigned two bytes), is added to the group used as initial code characters, it is used alone as a two-byte code for a phrase, and can also serve as the first character in multi-character codes, including three-byte codes where it is the first character (and is two bytes) and the second character is an ASCII character (which is one byte).

An embodiment employing the (Unicode Transformation Format) UTF-8 character encoding scheme used in internet transmission of over half the world's Web pages, assigns a single byte to all ASCII characters, two or three bytes to each of the great number of other characters used in most of the world's written languages and four bytes to some supplementary characters. The use of UTF-8 for network transmission of text makes possible a very sizable increase in the number of both two-character codes and three-character codes in the compression dictionary 116 of the embodiment. The total number of Unicode characters available today exceeds 100,000, about 65,000 of which are assigned as two-byte characters, while the number of two-byte codes used heretofore in the compression dictionary 116 of an illustrative embodiment using the GSM 03.38 character set seen on many phone networks was 7,225.

Tens of thousands more three-byte codes are available from the characters assigned three bytes in UTF-8, and allowing any ASCII character not used as initial characters in codes to follow these two-byte characters greatly increases the number of available three-byte codes. Additional four-character codes are created when following three-byte characters with an ASCII character. As a result of the great number of two-byte, three-byte and four-byte characters made available in UTF-8, compression of text in an embodiment using a network employing UTF-8 is even greater than that achieved with the character set used in GSM 03.38. In this embodiment, Web-page text is compressed prior to transmission, and then decompressed upon receipt by the client browser which has the same compression dictionary as the web site or other entity which compressed the text. The compression dictionaries used by both client browsers and web sites for such transmission are universal for any given written language.

Very significant compression for English and other alphabetic languages also can be found where a network, uses UTF-16, which assigns two or four bytes to every Unicode symbol and the number of Unicode symbols includes all characters used in almost every language. UTF-32 can also be used.

The techniques described above can also compress files where strings of bits assigned to one or more characters are other than strings of seven or eight bits.

In addition to being useful for text transmission, encoding of text is also useful for storage of text, in which case the requirement that the character set or sets used for encoding a text can be transmitted over one or more networks will, for some needs, be unnecessary.

In another embodiment of the invention, entries are added to the dictionary whenever a message that includes a word not found in the shared dictionary is sent from one member of a group to the others in the group. The action requires no added step by the sender of the message or by a recipient. If a word in the message is not found in the shared dictionary of the sender of the message it is added by computer 100 to the sender's copy of the shared dictionary 116 after the sender's device has sent the message and is added to the shared dictionary 116 of each recipient of the message as each recipient's device decodes the message. For example, in this embodiment, the word ‘widget’ can be included in a message to the group even though ‘widget’ is not in the shared dictionary. This is done as follows. During encoding, the word widget is preceded in the encoded string by the character # which is not used for any other purpose during encoding/decoding in this embodiment, and the word ‘widget’ is encoded very simply as ‘widget’ (or, alternatively, as ‘tegdiw’, a simple reversed spelling order to obscure the word from non-recipient readers) followed by the character ‘+’ which is also a character not otherwise used in this embodiment and indicates the end of the new word. The ‘+’ is then followed by ‘ion’, one of many unused codes resident in the dictionary 116 for the purpose of encoding new dictionary entries. Then ‘ion’ is followed by the character ‘=’ which also is not otherwise used. The character ‘=’ is used to indicate the end of the information needed to encode a phrase not previously in the shared dictionary. The word ‘widget’ then is added to the sender's dictionary with the code ‘ion’, after the message is encoded, and is added to the recipient's dictionary as the word ‘widget’ with the code ‘ion’ after the message is decoded. In the alternative embodiment where the word is sent with a backward spelling or other method of obfuscation, the obfuscation is anticipated and is corrected during decoding. Subsequent to this addition to dictionaries of both the sender and the other members of the group, the subsequent use of the invention between group members will encode the word ‘widget’ by the same process with which it encodes other entries existing in the group's shared dictionary.

### Message Threads for Short Messages

In yet another embodiment of the invention, a message thread is made possible for short messages including SMS and Tweets. When a message is received by a user it begins and ends with a designated symbol. The last four characters of the message is a code. The addition of the symbols and code indicates that the message has been placed as a phrase along with the indicated received code in a section of dictionary 116 on the sender's computer device designated for the purpose of storing messages, and will also be placed as a phrase with the same indicated code in a section on the recipient's computer designated for storing messages. When the recipient replies, the message to which the recipient is replying is displayed below the area of the display screen in which the sender will enter the reply. The message to which the sender is replying will then be sent as part of the reply, but will be replaced during the compression process by the code corresponding to the received message which has been stored with the code in a designated section of the sender's dictionary 116, and will be decoded and displayed during decoding by the recipient's computer device which has stored in its predetermined dictionary the same identifying code for the original message.

### Filtering Messages

Another feature of the invention is that it also serves as a message filter for unwanted messages, including SMS and e-mail spam and phishing messages, sent via a computer network including the Internet and mobile phone networks. The invention filters messages from both senders of messages who do not use the invention and senders who do use the invention but do not have the same shared dictionary as the intended message recipient. When a device using the invention receives a message, the invention expects the message to have been encoded using a dictionary shared by both the sender's device and the device of the recipient of the message and therefore will attempt to decode the text of the message. But an e-mail that has not been encoded, or has not been encoded using a dictionary shared by both the sender's device and the recipient's device cannot be decoded by the recipient's device and therefore can not be read by the recipient.

In one embodiment, if the message has not been encoded at all, but is instead ordinary readable text, the recipient's device will be unable to decode any group of characters not found as a code in the recipient's dictionary. This is seen easily in an example of an embodiment where the codes in the recipient's dictionary are all three characters long, yet the message includes phrases of various character lengths; none but the three character words can possibly be codes and consequently the message can not be decoded. And even any three-character words in the message would be rendered unreadable, since they would be assumed simply to be not words but codes for various phrases found in the dictionary with which they would be replaced during the failed decoding effort. But besides the fact that the message is rendered unreadable, the failed effort of the recipient's device to decode any group of characters in the message other than groups of three characters causes an error message on display 204.

If, in this embodiment, the message had instead been encoded on the sender's device using a dictionary different from that used on the recipient's device but based on the same dictionary principles—for example, codes of the same length as those used in the recipient's dictionary—there is no error code generated in this embodiment since the message is decoded by the recipient's device. Yet the decoding in such a case is unreadable since the codes do not represent the same phrases in each dictionary. As a result, there can be as many different groups using the invention as there are different dictionaries.

Among the advantages of encoding and decoding of messages using a group dictionary to filter spam, phishing, and other unwanted messages is that any link in the unwanted message that might send the user to an undesirable network location and/or to trigger a virus upload is not readable as a link. In one example, consider the following message:

For a free vacation, including free hotel & free air fare click here http://myfreestuff.com/clicktoday

If that message is not encoded using the dictionary used by the recipient, the result displayed on display 204 after the failed attempt at decoding using one of the many possible encoding/decoding dictionaries reads as follows:

R; >[that will and the were my own to oh Its she marriage Dz'$3 that j; 't for be will all all for examine policy his who in they will brain so that that budget departed from can ku %5=# gas D; 'z unbearable so . . . t˜″N& xFqff$/last a/be who he get, u4 (=E

This result of the failed decoding is not only unreadable but no longer shows the link of the original message. Had a different dictionary been used in the decoding effort, the result still would have been unreadable, merely different. Nor would the link shown in the original message be displayed.

While the human recipient of the message can readily see that the decoded message is gibberish, there are a number of ways in which failure of the received message to be properly decoded can be detected automatically, e.g., by decoding logic 120 ((1) without human intervention.

In one embodiment, decoding logic 120 uses conventional spell checking and grammar checking techniques to determine a degree to which the decoded message comports with spelling and grammar conventions of the language in which the recipient expects to receive messages. If the degree exceeds a predetermined threshold, decoding logic 120 determines that the message is not properly encoded and decoded.

In an alternative embodiment, decoding logic 120 determines that the message is not properly encoded and decoded by detecting errors in the encoding of the message. One technique involves recognition that the encoder of the message used a code not included in the recipient's dictionary. Another technique involves recognition of unnecessary quotation.

With respect to the first technique, it should be appreciated that some embodiments require that all text that is not codes represented in the decoding dictionary be quoted using a quotation flag. In embodiments in which codes can be adjacent to one another and whitespace therebetween can be assumed, all text that is not represented by a code is quoted using a quotation flag. If decoding such a message results in text that appears to be a code does not represent any code included in the decoding dictionary (e.g., that the codes processed in step 1510 are not found in the decoding dictionary), decoding logic 120 determines that the message is not properly encoded.

Anyone who discovers the particular encoding process expected by a user, specifically one who identifies the quotation flag, can generate a message that will decode properly by applying the quotation flag to each and every word of the message. Such would prevent decoding logic 120 from identifying any codes and from determining that any codes used in the subject message are missing from the dictionary used by decoding logic 120. Accordingly, decoding logic 120 can be configured to use unnecessary quotation as an indicator of improper encoding. When decoding logic 120 identifies text in the received message flagged with a quotation flag, decoding logic 120 can determine whether the quoted phrase is associated with a code within the dictionary used by decoding logic 120. If so, the quoted phrase could have been represented by a code and the quotation of the phrase was unnecessary and is recognized by decoding logic 120 as such. Unnecessary quotation recognized by decoding logic 120 is determined to indicate an improper encoding of the original message.

Encoding and decoding in the manner described above is also useful for microblogging, including tweets, where its use by a microblogger and followers will mean that only the followers of the microblogger can read the messages. The group of followers can be as small as one or as large as the network will allow. Microbloggers can include individual commercial entities and other organizations, as well as individuals.

In one embodiment, the message as received—the undecoded message—is stored in a separate file before the decoding effort so that the user or security personnel can choose to access the original message it if desired, despite its having been unreadable after the decoding effort is applied and an error message displayed as a result of the failed decoding effort. In another embodiment, messages causing the display of an error message during the decoding effort are simply made unavailable in their original form.

### Compression and Encryption

It should be observed that encoding text in the manner described above obfuscates the text, at least partially. Such obfuscation can be viewed as a form of encryption of the message. Since using the techniques described above to compress a text file also naturally encrypts it, privacy of communication is greatly enhanced, rendering a message that would discourage everyone but cryptographers. In an embodiment which further enhances security for groups of users, codes and the phrases they represent can be scrambled randomly to create an enormous number of different dictionaries for any language. Consequently, in order to maintain a group's privacy of communication when using the invention, the group can request a new dictionary whenever they think it necessary, including, for example, a time when a member leaves the group. In this embodiment the new dictionary is downloaded from a central network source, much as is done now with various updates—including anti-virus updates—on the internet. If the group is a group of users whose messages are all handled by the same message handler—including Internet Service Providers including Earthlink, Web Mail handlers including Gmail, short message handlers including Twitter—assignment and management of group dictionaries and group codewords are centrally handled, obviating the need for the user to download dictionaries or codewords, thereby increasing security. In another embodiment, software on the users' devices can scramble the dictionary.

In another embodiment, members of a group, including groups using the invention, can receive messages that are unencrypted or are encrypted differently than described herein if the message includes the group's codeword. Such messages include text compressed by methods other than that described herein whenever the text includes the group codeword and can be decompressed, decrypted or both decompressed and decrypted by means of a capability included in the user's computer device. For example, a message that has been zipped—i.e., compressed by any one of many familiar techniques—can be read by a recipient in the group if the zipped message includes the zipped file's compression-translation dictionary and the group's codeword, and the recipient's device has the capability to unzip the file.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for compressing computer-readable text data stored on a computer-readable medium, the method comprising:
parsing one or more phrases from the text data wherein the phrases includes one or more words, each of which includes at least one word character and no non-word characters;
for each of the one or more phrases:
determining whether the phrase can be represented by a code according to a predetermined dictionary that is created without reference to the text data;
if the phrase can be represented by a code according to the predetermined dictionary, including the code in place of the phrase in a body of encoded text; and
if the phrase cannot be represented by a code according to the predetermined dictionary, including the phrase in the body of encoded text; and
storing the body of encoded text in a computer-readable storage medium;
wherein the codes are each associated within the predetermined dictionary with a phrase that includes one or more words, each of which includes at least one word character and no non-word characters and predetermined whitespace at one end of the phrase.
